(19) United States
(12) Patent Application Publication
(10) Pub. No.: US 2010/0302762 A1
(43) Pub. Date: Dec. 2, 2010

(54) ANTI-GLARE LED LAMP AND TUNNEL ILLUMINATION SYSTEM HAVING THE SAME

(75) Inventor: YOU-XUE LIU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/543,514

(22) Filed: Aug. 19, 2009

(30) Foreign Application Priority Data
May 27, 2009 (CN) 200910302676.5

(51) Int. Cl. F21S 8/00; F21S 4/00; F21V 7/00

(52) U.S. Cl. 362/147; 362/249.02; 362/235

(57) ABSTRACT

An LED lamp comprises a heat sink and a plurality of lighting units. The heat sink comprises a base plate, a plurality of fins extending upwardly from a top surface of the base plate, and a plurality of supporters extending downwardly from a bottom surface of the base plate. The supporters are inclined to a same direction. The lighting units are mounted on the supporters, respectively, to illuminate a same direction, which is toward a vehicle moving in a tunnel and toward the LED lamp.

### BACKGROUND

1. Technical Field

The disclosure relates to illumination apparatuses and, particularly, to an anti-glare LED (light emitting diode) lamp and a tunnel illumination system including such an anti-glare LED lamp.

2. Description of Related Art

Since LEDs feature advantages of high brightness, power saving and long life expectancy, LEDs have been used extensively for illuminations. Several LEDs are usually arranged and connected to a circuit board to form an LED lamp and several LED lamps are connected in series or in parallel to constitute an LED lamp module to achieve an illumination effect that meets the requirements for a large projecting area and a high brightness for road illuminations such as a road in a tunnel. Conventionally, when LED lamps illuminate the road, glare may occur to cause discomfort to human eyes. Particularly at night, the glare troubles drivers to thereby may cause more traffic accident.

What is needed, therefore, is an anti-glare LED lamp and a tunnel illumination system including such an anti-glare LED lamp, which can overcome the described limitations.

### BRIEF DESCRIPTION OF THE DRAWINGS

Many aspects of the present apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is an isometric, exploded view of an anti-glare LED lamp in accordance with an embodiment of the disclosure.

FIG. 2 is an inverted view of FIG. 2.

FIG. 3 is an assembled view of FIG. 1.

FIG. 4 is a cross-sectional view of the anti-glare LED lamp along line IV-IV of FIG. 3.

FIG. 5 is a schematic view showing a relation between a lighting direction of the anti-glare LED lamp of the disclosure and a vehicle moving in a tunnel.

### DETAILED DESCRIPTION

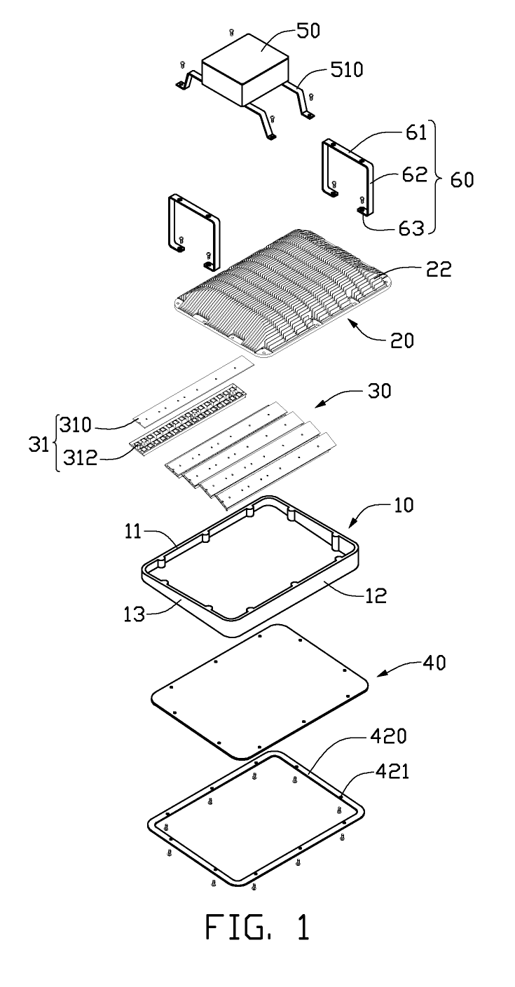

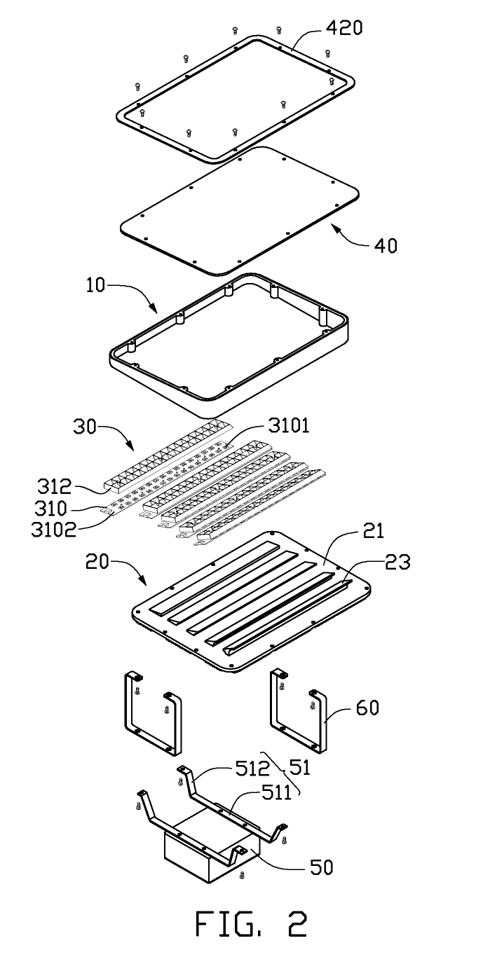

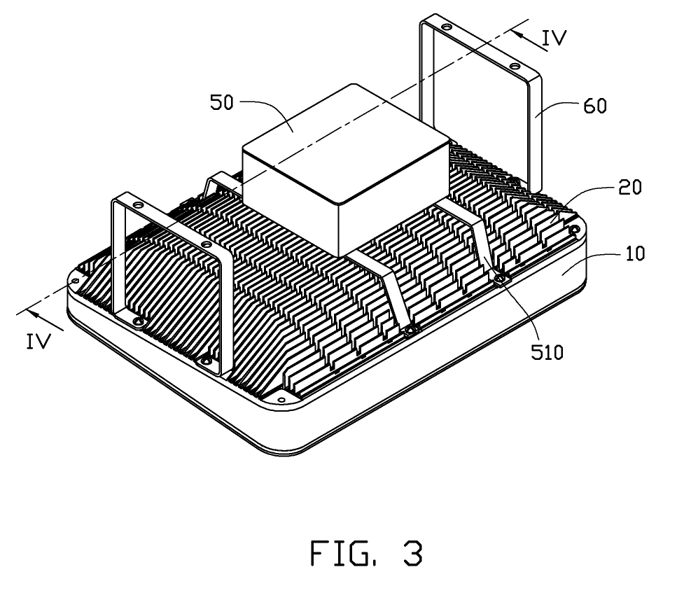

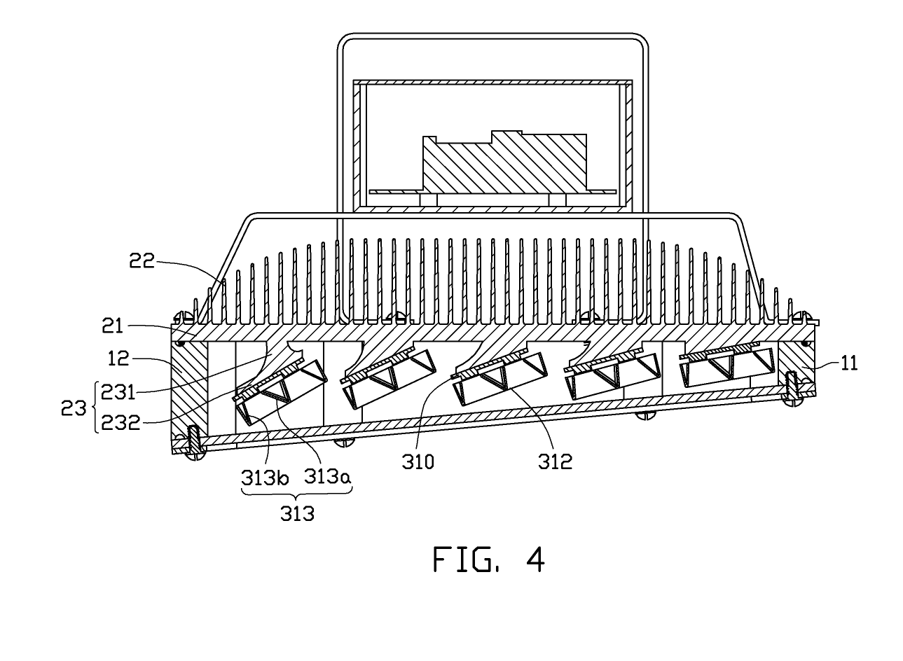

Referring to FIGS. 1-3, an LED lamp includes a frame 10, a heat sink 20, a light source 30, a transparent envelope 40, and a power supply module 50. The frame 10 includes first and second rectangular walls 11, 12, and two third trapezium-shaped walls 13 connecting two ends of the first and second walls 11, 12. The first, second and two third walls 11, 12, 13 are flat plates and cooperatively surround an enclosed space with top and bottom openings. The heat sink 20 and the envelope 40 are mounted to top and bottom sides of the frame 10 to cover the top and bottom openings of the space defined by the frame 10. The frame 10 includes a top surface and a bottom surface. When the frame 10 is so placed that the top surface of the frame 10 is on a horizontal plane, the bottom surface of the frame 10 is inclined to the horizontal plane (better seen in FIG. 4).

Referring to FIG. 4, the heat sink 20 is made of a metal with a high heat conductivity, such as aluminum. The heat sink 20 includes a base plate 21, a plurality of fins 22 extending upwardly from a top surface of the base plate 21, and a plurality of supporters 23 extending downwardly from a bottom surface of the base plate 21. The base plate 21 is fixed on the top surface of the frame 10, the envelope 40 is fixed to the bottom surface of the frame 10; thus, the frame 10, the base plate 21 and the envelope 40 cooperatively form an illuminating chamber thereamong, which is coincident with the enclosed space surrounded by the first, second and third walls 11, 12, 13 of the frame 10. The light source 30 is secured to the supporters 23 and is contained in the illuminating chamber. The base plate 21 is a rectangular metallic plate which has two short edges respectively corresponding to the two third walls 13 of the frame 10 and two long edges respectively corresponding to the first and second walls 11, 12 of the frame 10. Each of the supporters 23 is an elongated, plate-like structure which extends from one short edge of the base plate 21 to the opposite short edge of the base plate 21. The supporters 23 are equidistantly arrayed in a row along a traverse direction of the base plate 21, from one long edge of the base plate 21 to the opposite long edge of the base plate 21. The supporters 23 are parallel to the long edges of the base plate 21.

Each of the supporters 23 includes an extension plate 231 protruding downwardly from the bottom surface of the base plate 21 and a supporting plate 232 formed on a free end of the extension plate 231. The supporting plates 232 of the supporters 23 are flat plates and face a same direction. The light source 30 includes a number of lighting units 31 mounted to the supporting plates 232, respectively. Due to all of the supporting plates 232 facing the same direction, all of the lighting units 31 emit light illuminating a same direction. The supporting plates 232 each have an inclined angle so that one supporting plate 232 is angled with the bottom surface of the base plate 21. In the illustrated embodiment, the supporting plates 232 each are angled with a right end of the bottom surface of the base plate 21 at an acute angle. The inclined angles of supporting plates 232 can gradually decrease or increase along a direction from left to right of the base plate 21.

In order to have a better illumination characteristic, a number of light guide structures 312 are provided in the light source 30. In the present embodiment, each of the lighting units 31 includes an LED module 310 including a number of LEDs 3101 mounted on a printed circuit board 3102, and a light guide structure 312 mounted on the printed circuit board 3102 and enclosing the LEDs 3101. The printed circuit board 3102 is attached on one supporting plate 232 and thermally connects therewith, whereby heat generated by the LEDs 3101 can be transferred to the heat sink 20 and then dissipated to ambient air via the fins 22. The light guide structure 312 is an integral structure which includes a number of light reflecting barrels 313 each enclosing a corresponding LED 3101. Each of the light reflecting barrels 313 of the light guide structure 312 corresponds to one LED 3101 to adjust the lighting direction of the LED 3101 and diffuse the light generated by the LED 3101. Each of the light reflecting barrels 313 includes a smaller open end, a larger open end opposite to the small open end, and a cone-shaped reflective surface between the small and larger open ends. The smaller open end is located near the corresponding LED 3101, while the larger open end is distant therefrom.

In the present embodiment, as shown in FIG. 4, each of the light reflecting barrels 313 is a dissymmetrical, cone-shaped barrel which has an inclined, upper first reflective section 313a and an inclined, lower second reflective section 313b. An angle between the first reflective section 313a and the corresponding LED 3101 is larger than that between the second reflective section 313b and the corresponding LED 3101. A length of the first reflective section 313a is larger than that of the second reflective section 313b. An inclined angle of the first reflective section 313a relative to a lateral side of the corresponding LED 3101 is equal to or less than 70°. By the inclined angle of the supporting plates 232 and the inclined angle of the first reflective section 313a of the light reflecting barrel 313, the LED lamp in accordance with the disclosure can obtain the desired lightening direction. For example, in FIG. 4, the inclined angle of the first reflective section 313a of the light reflecting barrel 313 relative to the lateral side of the corresponding LED 3101 is equal to 70°; the inclined angles of the first to fifth supporting plates 232 to the base 21 are 30°, 25°, 20°, 15°, 10°, respectively, which are gradually decreased at an interval of 5°.

The envelope 40 is made of transparent plastic material and is sandwiched between a retaining ring 420 and the bottom surface of the frame 10. The power supply module 50 is secured to the base 21 of the heat sink 20 by two fixing structures 510. Each of the two fixing structures 510 is made of a metal plate and structured to have a configuration of an inverted U-shaped bracket. Each fixating structure 510 includes a flat part 511 and two connection parts 512 extending downwardly from two ends of the flat part 511. The two connection parts 512 of each of the fixing structure 510 are fixed on the two longer edges of the base plate 21 of the heat sink 20, respectively; the flat part 511 of each of the fixing structures 510 bestrides over the fins 22 of the heat sink 20. The two fixing structures 510 are parallel to each other, and the power supply module 50 is mounted on the two flat parts 511 of the two fixing structures 510.

Two suspension structures 60 are mounted to two shorter edges of the base plate 21 of the heat sink 20, respectively, to secure the LED lamp to a ceiling or other predetermined position. Each of the two suspension structures 60 includes a level arm 61, two vertical arms 62 perpendicularly and downwardly extending from two ends of the level arm 61, and two fixing parts 63 horizontally and inwardly extending from free, bottom ends of the two vertical arms 62, respectively. The two fixing parts 63 of each of the two suspension structures 60 are mounted to the base plate 21 of the heat sink 20, whereby the two suspension structures 60 are secured to the base plate 21 of the heat sink 20. The level arms 61 of the two suspension structures 60 define a number of screw holes (not labeled); a number of screws (not shown) extend through the screw holes of the level arms 61 and screw in the ceiling, whereby the LED lamp is secured to the ceiling.

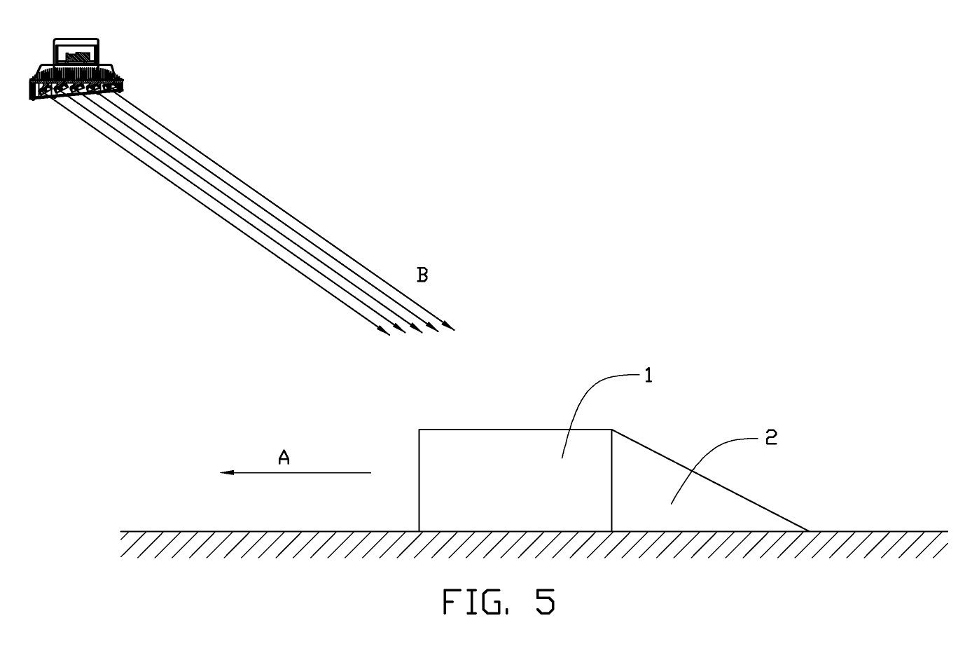

FIG. 5 shows that the LED lamp is used for tunnel illumination. The heat sink 20 is horizontally secured to a ceiling of the tunnel by the two suspension structures 60. The supporting plates 232 of the heat sink 20 are inclined to the road and face a driving direction A of a vehicle 1. Thus, the lighting direction B of the LEDs 3101 mounted on the supporting plates 232 are opposite to the driving direction A of the vehicle 1. In this state, the vehicle 1 has a clear shadow 2 which can be clearly seen by drivers in the vehicles behind the vehicle 1. That is, the shadow 2 facilitates the driver behind the vehicle 1 to better judge the conditions of the vehicle 1, for example, position, appearance and speed of the vehicle 1 to thereby have a safer driving. It is understood that other objects on the road and in front of the driver can also be illuminated to produce shadows so that the drive can better judge the positions and appearances of these objects to avoid these objects thereby to have a safer driving.

It is to be understood, however, that even though numerous characteristics and advantages of the present embodiments have been set forth in the foregoing description, together with details of the apparatus and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

1. An LED lamp comprising:
a heat sink comprising a base plate, a plurality of fins extending upwardly from a top surface of the base plate, and a plurality of supporters extending downwardly from a bottom surface of the base plate, the supporters being inclined to a same direction; and
a plurality of lighting units mounted on the supporters, respectively, to illuminate a same direction.

2. The LED lamp of claim 1, wherein the base plate of the heat sink has two long edges and two short edges, each of the supporters is an elongated, plate-like structure extending from one short edge of the base plate to another opposite short edge of the base plate.

3. The LED lamp of claim 2, wherein the supporters are equidistantly arrayed in a row from one long edge of the base plate to another opposite long edge of the base plate, and are parallel to the long edges.

4. The LED lamp of claim 3, wherein each of the supporters comprises an extension plate protruding downwardly from the bottom surface of the base plate and a supporting plate formed on a free end of the extension plate, the supporting plates of the supporters are flat plates and face the same direction.

5. The LED lamp of claim 4, wherein the supporting plates each have an inclined angle with the bottom surface of the base plate.

6. The LED lamp of claim 5, wherein the inclined angles of the supporting plates gradually decrease along a traverse direction of the base plate.

7. The LED lamp of claim 4, wherein the lighting units each comprise a printed circuit board, a plurality of LEDs mounted on the printed circuit board, and a light guide structure on the printed circuit board and enclosing the LEDs.

8. The LED lamp of claim 7, wherein the light guide structure is an integral structure having a plurality of light reflecting barrels, each of the light reflecting barrels corresponds to one LED to adjust lightening characteristic of the one LED.

9. The LED lamp of claim 8, wherein each of the light reflecting barrels comprises a smaller open end, a larger open end opposite to the small open end, and a cone-shaped reflective surface connected between the small and larger open ends, the smaller open end is located near the one LED, the reflective surface encloses the one LED therein and the larger open end is distant from the one LED.

10. The LED lamp of claim 9, wherein each of the light reflecting barrels is dissymmetrical cone-shaped and has an inclined first reflective section and an opposite inclined second reflective section, and a length of the first reflective section is larger than that of the second reflective section.

11. The LED lamp of claim 10, wherein an inclined angle of the first reflective section relative to a lateral side of the one LED is not larger than 70°.

12. The LED lamp of claim 1, further comprising an enclosed frame with top and bottom openings, the bottom surface of the base plate of the heat sink is secured to a top side of the frame to cover the top opening, and the light source is contained in the frame.

13. The LED lamp of claim 1, further comprising a transparent envelope secured to a bottom side of the frame to cover the bottom opening of the frame.

14. A tunnel illumination system comprising:
a tunnel having a ceiling; and
an LED lamp horizontally secured to the ceiling, the LED lamp comprising a base plate parallel to the ceiling and a plurality of lighting units mounted to a bottom surface of the base plate, the lighting units being angled with the base plate toward a same lateral side of the LED lamp so that light beams generated by the lighting units project toward a same side of the tunnel;
wherein the light beams project in a direction toward a vehicle moving in the tunnel and toward the LED lamp.

15. The tunnel illumination system of claim 14, wherein the lighting units each comprise a printed circuit board, a plurality of LEDs mounted on the printed circuit board, and a light guide structure on the printed circuit board and enclosing the LEDs.

16. The tunnel illumination system of claim 15, wherein the light guide structure is an integral structure having a plurality of light reflecting barrels, each of the light reflecting barrels corresponds to one LED to adjust lighting characteristic of the one LED.

17. The tunnel illumination system of claim 16, wherein the light reflecting barrels each comprise a smaller open end, a larger open end opposite to the small open end, and a cone-shaped reflective surface connected between the small and larger open ends, the smaller open end located near the one LED, the larger open end is distant from the one LED, and the reflective surface encloses the one LED therein.

18. The tunnel illumination system of claim 17, wherein each of the light reflecting barrels is dissymmetrical cone-shaped and has an inclined first reflective section and an opposite inclined second reflective section, and a length of the first reflective section is larger than that of the second reflective section.

19. The tunnel illumination system of claim 18, wherein an inclined angle of the first reflective section to a lateral side of the one LED is not larger than 70°.
